(19) United States
(12) Patent Application Publication
(10) Pub. No.: US 2015/0254241 A1
(43) Pub. Date: Sep. 10, 2015

(54) HELP DESK SEARCH ENGINE

(71) Applicant: BANK OF AMERICA CORPORATION, Charlotte, NC (US)

(72) Inventor: Aldrin Ming Fat T. Si, Pasay City (PH)

(73) Assignee: BANK OF AMERICA CORPORATION, Charlotte, NC (US)

(21) Appl. No.: 14/195,984

(22) Filed: Mar. 4, 2014

(51) Int. Cl. G06F 17/30

(52) U.S. Cl. CPC G06F 17/30014; G06F 17/30864; G06F 17/30896

(57) ABSTRACT

Embodiments of the invention relate to systems, methods, and computer program products for providing a searchable shared drive. The system, method, and computer program product are configured to: (a) provide a search engine tool configured for searching a central database receiving information and documents from a plurality of data sources within a business entity; (b) receive, via the search engine tool, a search query, wherein the search engine tool comprises an interface for receiving the search query; (c) in response to receiving the search query, perform a search of the central database using key elements from the search query; and (d) provide results of the performed search to a display accessible to a user.

### BACKGROUND

Technical help desk representatives aim to provide assistance efficiently to clients inquiring for help. However, it is sometimes difficult for the representatives to search for and locate helpful information and/or documents for assisting their clients because the information and/or documents are located in varying applications within their computers or otherwise. This, in some instances, may cause significant delays and deviations in client service metrics for the representatives. As such, there exists a need for an invention that improves the efficiency in searching for and locating helpful information or documents for assisting a client.

### BRIEF SUMMARY OF THE INVENTION

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

An invention for providing a centralized database that receives documents and information from multiple data resources together with an associated search engine that allows a user to effectively search the centralized database is provided. In some embodiments, the invention includes a computer apparatus including a processor and a memory; and a software module stored in the memory, comprising executable instructions that when executed causes the processor to: (a) provide a search engine tool configured for searching a central database receiving information and documents from a plurality of data sources within a business entity; (b) receive, via the search engine tool, a search query, wherein the search engine tool comprises an interface for receiving the search query; (c) in response to receiving the search query, perform a search of the central database using key elements from the search query; and (d) provide results of the performed search to a display accessible to a user.

In some embodiments, the invention is configured to provide an interface for the central database configured for managing the central database, wherein managing the central database includes adding or deleting information or documents from the central database.

In some embodiments, using the interface for the central database, information and/or documents are entered into the central database.

In some embodiments, the results of the search comprise one or more hyperlinks to information and/or document in the central database.

In some embodiments, the invention is configured to use a computer processor to identify, at each of the plurality of data sources, information or documents relating to information or documents previously stored within the central database.

In some embodiments, the computer processor associated with each of the identified information or documents a selectable input feature, when selected by a user, automatically copies the information or documents from the data source to the central database.

In some embodiments, identifying the information or documents comprises associating an indicator with each of the identified information or documents, wherein the indicator is any one or more of a highlighting, flagging, or otherwise differentiating the identified information or documents from other information or documents at the data source.

### BRIEF DESCRIPTION OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a system and method for providing a central database receiving information from a plurality of data sources and a search engine tool allowing a user to search and retrieve documents from the central database, in accordance with some embodiments of the present invention;

FIG. 2 illustrates an environment for providing a central database receiving information from a plurality of data sources and a search engine tool allowing a user to search and retrieve documents from the central database, in accordance with an embodiment of the invention;

FIG. 3 is, illustrates a more detailed description of one exemplary embodiment of a system environment of the invention, in accordance with various embodiments of the present invention;

FIG. 4 illustrates a general process flow of a method for managing a central database of the present invention is provided, in accordance with an embodiment of the present invention; and

FIG. 5, illustrates an exemplary search screen, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, and/or operational aspects of any of the embodiments of the present invention described and/or contemplated herein may be included in any other embodiment of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

In general terms, embodiments of the present invention relate to methods, systems, apparatus, and computer program products providing a centralized database with an associated search engine tool. More specifically, the centralized database is associated with one business entity and may be used by the one business entity to store documents, files, and other information from multiple computers and data sources into the centralized database. This allows for ease and efficiency in locating the documents. However, because the centralized database may include a great amount of documents, files, and other information an associated search engine tool is provided for identifying documents, files, and other information of interest to a user.

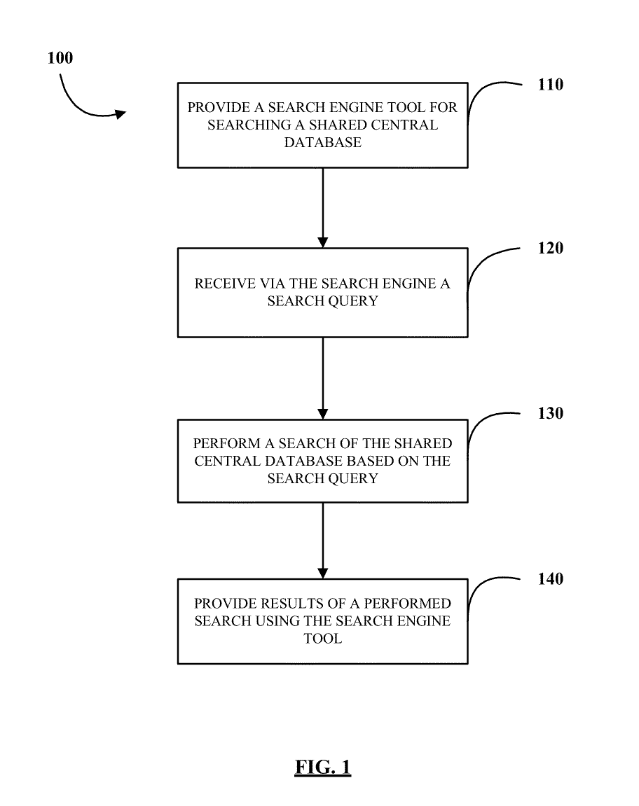

Referring now to FIG. 1, a general process flow 100 of a system for providing a centralized database with an associated search engine tool is provided. As represented by block 110, the system is configured to provide a search engine tool for searching a central database receiving information and documents from a plurality of data sources within a business entity. As represented by the block 120, the system is configured to receive, via the search engine tool, a search query. As represented by block 130, the system is configured to in response to receiving the search query, perform a search of the central database. Further, as represented by block 140, the system is configured to provide results of the performed search to a user.

Accordingly, the system having the process flow 100 enables a technical help desk agent or similar assistance center personnel within a business to easily identify helpful documents, files, or other information without having to search within multiple applications or document folders on a local computer. The centralized database and search tool allows a technical help desk agent to quickly obtain documents or information that may aid in responding to a request or question from an internal or an external business clients. And, as a result, many of the metrics for measuring the responsiveness and efficacy of a technical help desk for the business are improved substantially over the metrics of a technical help desk without the centralized database and search engine tool.

Regarding the block 110, a system executing process flow 100 provides a search engine tool for searching the central database. In some embodiments, the search engine tool comprises a separate search interface accessible via a graphical interface of a user. In such an embodiment, the search interface for the search engine tool may include one or more input boxes, search fields, or other designated area within the search interface for a user to provide a search query, a search string, or other input. The search query or search string, in some embodiments, is a word or phrase. However, the search query or the search string can be any combination of letters, numbers, symbols, spaces, and the like. As an example, a user may enter comprising a combination of a word and numbers, such as the search query “Example 123_{—}123” into an input box of the search interface. Additionally, the search query or search string may include wildcards, such as an asterisk (*), on either end of the search query or string. Boolean functions may also be included in the search query or string in order to further refine a user's search.

In some embodiments, the search interface of the search engine tool may communicate a search query over a network connecting a work station or computer of an agent or employee of a business to the central database of the business. In some embodiments, the central database is a dedicated storage device or server that is maintained by the business or otherwise by a third party vendor of the business. In other embodiments, the central database may comprise multiple storage devices or servers with a primary purpose for managing and storing documents, files, and information for implementing the search engine tool.

In operation, in some embodiments, the central database is configured to receive information from a plurality of data resources throughout the business entity. For example, in some embodiments, the central database automatically receives information from one or more applications operating on one or more computer workstations in a business entity. In such an example, the central database may receive information from an e-mail application of employee of the business, a local drive of an employee's computer, or some other application resident on a computer of the business. In another example, in some embodiments, the central database receives information by manual addition from a user or agent of the business. In such an embodiment, an agent of the business may use an add/remove feature to manually add into the central database information which the user desires to be accessible using the search engine tool. In a further example, in some embodiments, the central database receives information from third party information feeds, such as a news feed, to which the business or one or more of the agents of the business have a subscription. It will be understood that the central database may receive information from the business or the affiliates of the business in a number of ways, which should not be limited to the examples provided above.

Regarding the block 120, the system executing process flow 100 receives via the search interface, a search query or search string from a user. A user may provide the search query or search string in a number of ways including using one or more input devices, such as a keyboard, touch interface, voice command, gesture commands, or the like. Once the search engine tool receives the search query from the search interface, the system may analyze the search query in order to identify key terms, key words, or other key elements for performing an effective search of the central database. It will be understood that the term “identify,” as used herein, is meant to have its ordinary meaning (i.e., its ordinary dictionary definition) in addition to the one or more ordinary meanings of the following terms: discover, learn, calculate, observe, read, decide, determine, collect, conclude, verify, ascertain, and/or the like. The system may identify the key elements in the search query by comparing the elements of the search query to previously identified key elements or key elements that are currently associated with documents, files, hyperlinks, or other information in the central database.

Regarding the block 130, it will be understood that the system having the process flow 100 is configured to perform a search of the central database based at least partially on receiving the search query. It will be understood that the search may be performed in real-time or near real-time, immediately after a user has entered the search query. In this way, results may be provided in a very short time after entering the search information (e.g., 1 second—4 seconds, or the like). In some embodiments, in performing the search, the system uses the identified key elements from the search query or search string to query the central database in order to locate relevant documents, files, hyperlinks, or other information. For example, the key elements in a search phrase, such as “Example 123_{—}123”, may be the term “Example” and the numbers “123.” In such an example, the system may identify or locate any documents, files, or other information within the central database with either or both of the key elements in its title or body of the document or file. The system may additionally retrieve any of those identified or located documents, files, or other information for subsequent output to the user, storage, or additional analysis and refinement by the system.

Referring now to block 140, it will be understood that the system having the process flow 100 is configured to output results of the performed search to a user. In some embodiments, the system provides the results of the search to a user by populating a display of a graphical user interface associated with the user with one or more documents, files, or other information associated with the search query of the user. In other embodiments, the system is configured to output the results of the search by communicating the results via e-mail, print out, or other communication medium. In some embodiments, each of the items in the results of the search is a selectable hyperlink or other selectable input feature. In this way, in order to view the document, file, or other information associated with the results the user may select the hyperlink and a new tab, new window, or the current window of the graphical user interface may display the document, file, or other information.

It will further be understood that the system having the process flow 100 can be configured to perform any of the portions of the process flow 100 represented by blocks 110-140 upon or after one or more triggering events (which, in some embodiments, is one or more portions of process flow 100). As used herein, “triggering event” refers to an event that automatically triggers the execution, performance, and/or implementation of a triggered action, either immediately, nearly immediately, or sometime after (e.g., within minutes, etc.) the occurrence of the triggering event. For example, in some embodiments, the system having process flow 100 is configured such that the system receiving the search query (the triggering event) automatically and immediately or nearly immediately triggers the system to analyze the search query and perform a search of the central database (the triggered action).

Also, it will be understood that, in some embodiments, a predetermined time and/or the passage of a predetermined period of time may serve to trigger one or more of the portions represented by the blocks 110-140. It will also be understood that, in accordance with some embodiments, the system having the process flow 100 is configured to automatically perform one or more of the portions of the process flow 100 represented by the blocks 110-140, whereas in other embodiments, one or more of the portions of the process flow 100 represented by the blocks 110-140 require and/or involve human intervention. Of course, in addition to the system having the process flow 100, it will be understood that any of the embodiments described and/or contemplated herein can involve one or more triggering events, triggered actions, automatic actions, and/or human actions.

In addition, it will be understood that, in some embodiments, the system having the process flow 100 (and/or a user thereof) is configured to perform each portion of the process flow 100, from start to finish, within moments, seconds, and/or minutes (e.g., within approximately 10-15 minutes, etc.). In some embodiments, the system having the process flow 100 can be configured to perform one or more portions of the process flow 100 in real time, in substantially real time, and/or at one or more predetermined times. Further, it will be understood that the number, order, and/or content of the portions of the process flow 100 are exemplary and may vary. It will further be understood that the system having the process flow 100 can be configured to perform any one or more of the portions of any one or more of the embodiments described and/or contemplated herein, including, for example, any one or more of the portions of the process flow 400 described later herein.

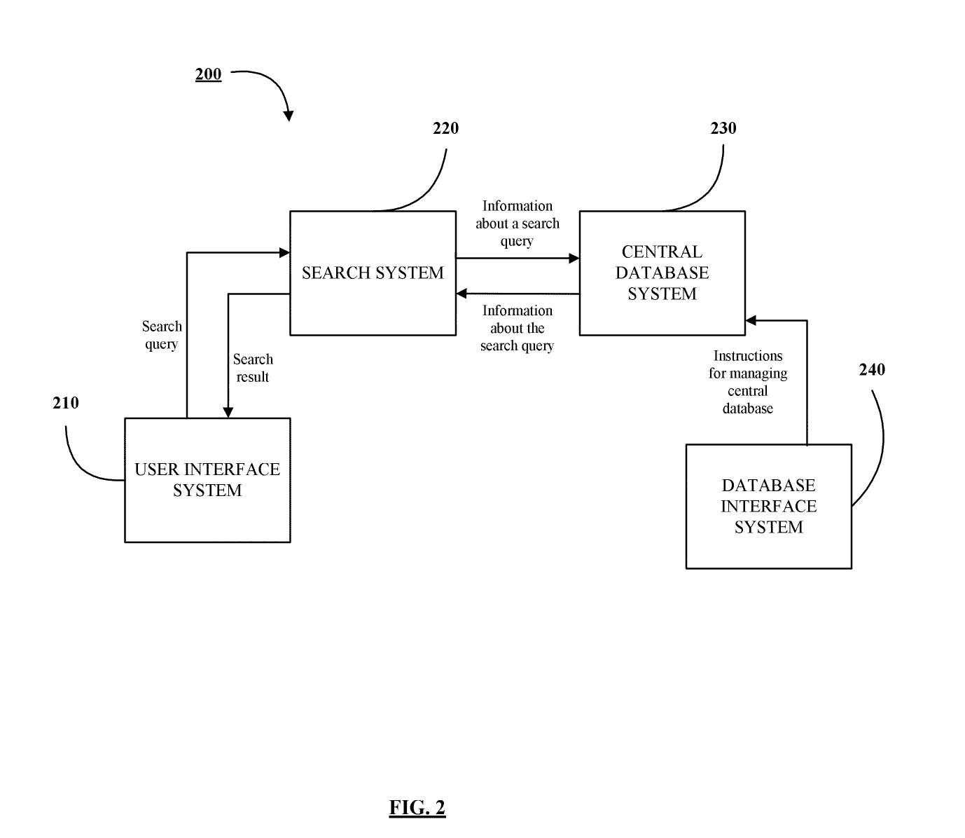

FIG. 2 illustrates an environment 200 for providing a searchable central database for a business entity, in accordance with an embodiment of the present invention. The environment 200 includes user interface system 210, search system 220, central database system 230, and central database interface system 240. User interface system 210 is operatively in communication over a network with search system 220. Search system 220 is also in operable communication over a network with central database system 230. Central database interface system 240 is operatively in communication with central database system 230.

User interface system 210 is configured to receive a search query from a user, send a search query to the search system 220, and display results of the search query to the user. Search system 220 is configured to receive a search query, send information about a search query, and send a search result based at least partially on a search query. Central database interface system 240 is configured to display a graphical user interface for managing central database system 230 and receive instructions for modifying by adding or removing content from central database 230. Central database system 230 is configured to receive information for multiple data resources within a business entity and/or from affiliates of the business entity.

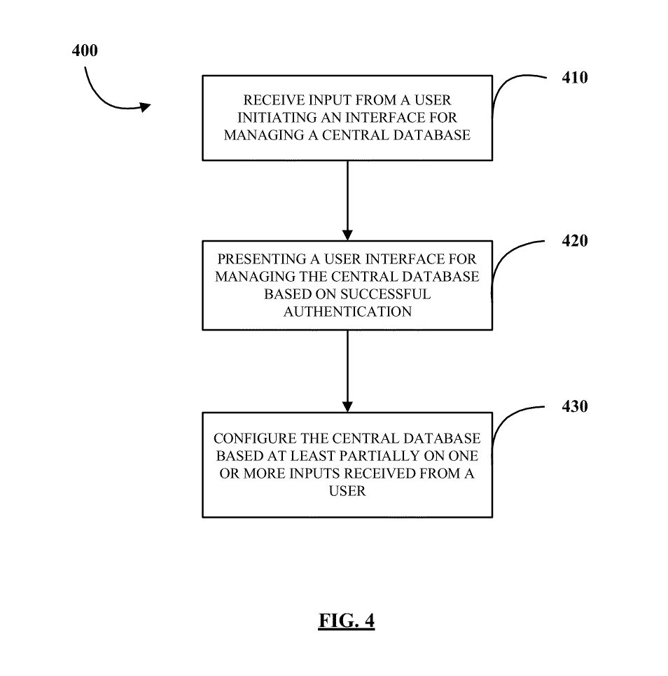

In one embodiment of the invention, system 200 is configured to perform the processes illustrated in FIG. 1 and in FIG. 4. Accordingly, the user enters a search query into user interface system 210, which is then sent to search system 220. Search system 220 receives the search query, performs a search of the central database system 230, and returns a search result to user interface system 210 based at least partially on the search query. The User interface system 210 then presents, via a graphical user interface, the search results to user. The order of the processes described above is merely exemplary and may vary.

Although FIG. 2 depicts the user interface system 210, search system 220, central database system 230, and central database interface system 240 as separate systems, the systems may or may not be performed by different hardware, software, or entities. For example, in one embodiment, some or all of these systems may be combined into a single system using the same software and/or hardware, i.e. search system 220 and user interface system 210 may be portions of a single interface and search system configured to receive a search query and perform a search by sending a query to the central database system 230. In other embodiments, each system has its own hardware and/or software and does not share its hardware and/or software with the other systems. In some embodiments, some or all of the systems in the system 200 may be separated into two or more distinct entities, where each system uses different hardware and/or software to perform their respective functions.

In addition, the system illustrated in FIG. 2 may be controlled, operated, maintained, etc. (hereinafter “maintained”) by the same or separate parties. For example, a user may maintain the user interface system 210, a bank or its agent may maintain the search system 220 and a third party vendor may maintain the central database interface system 240 and central database system 230. As another example, a bank may maintain the entire system 200, including user interface system 210, search system 220, central database system 230, and central database interface system 240.

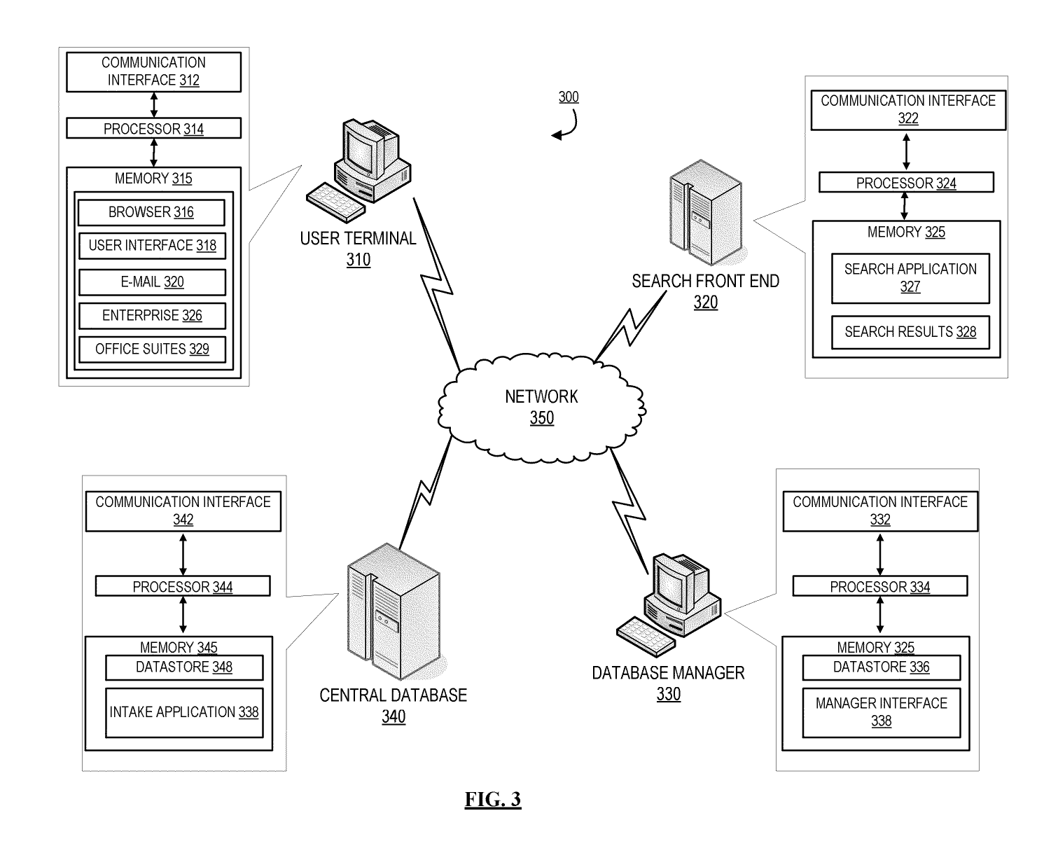

Referring now to FIG. 3, system 300 is provided to illustrate a more detailed description of one exemplary embodiment of the invention. The system and processes described in FIG. 3 is directed at a search engine application useable to search a central database or shared drive which receives data and information from a plurality of data resources within one business entity in order to improve client service. For example, a bank employee may enter the phrase “computer help” into a search field of the employee's computer that incorporates searchable central database system 300.

Referring now specifically to FIG. 3, a searchable central database system 300 is provided, which includes a user terminal 310, search front end 320, database manager 330, central database 340, and network 350. The systems that make up the searchable central database system 300 may be communicatively coupled with one or more networks. The network 350 linking the user terminal 310, search front end 320, database manager 330, and/or central database 340 to one another may include a local area network (LAN), a wide area network (WAN), and/or a Global Area Network (GAN), such as the Internet. The networks may comprise wireless and/or wireline technology.

The user terminal 310 is operatively coupled to the search front end 320 and the central database 340, and may include, for example, a personal computer system, a mobile phone, a personal digital assistant, a kiosk, or other type of computing device. As illustrated, the terminal 310 comprises a communication interface 312, processor 314, memory 315 having a browser application 316, user interface 318, e-mail application 320, enterprise applications 326, and office suites 329.

The communication interface 312, like all other communication interfaces described herein, is comprised of hardware, and, in some instances, software, that enables one or more portions of the searchable central database system 300, such as user terminal 310, to transport, send, receive, or otherwise communicate information to and/or from the communication interface of another portion of the searchable central database system 300. For example, the communication interface 312 may include a modem, server, or other electronic device that communicatively couples the user terminal 310 to another electronic device, such as the electronic devices that make up the search front end 320, and the central database 340, and/or one or more networks linking the user terminal 310 to these other portions of the searchable central database system 300.

The processor 314, like all other processors described herein, includes circuitry required for implementing audio, visual, and/or logic functions of the user terminal 310. For example, the processor 314 may be comprised of a digital signal processor device, a microprocessor device, and various analog-to-digital converters, digital-to-analog converters, and other support circuits. Control and signal processing functions of the user terminal 310 are allocated between these devices according to their respective capabilities. The processor 314 may include functionality to operate one or more software programs based on computer-readable instructions thereof, which may be stored in the user terminal's memory 315, such as the browser application 316 and the e-mail application 320.

The browser application 316 may be any computer-readable instructions configured to allow the terminal to communicate with other devices over a network using, for example, one or more network or system communication protocols. For example, in one embodiment the browser application 316 comprises an intranet browser used by the user terminal 310 for sending a search query, receiving and displaying a search result, and facilitating a chat session.

The e-mail application 320 may be any computer-readable instructions configured to allow a user of user terminal 310 to send and receive electronic mail. For example, in one embodiment the e-mail application 320 comprises an inbox and a feature for composing electronic mail so that the user can receive e-mail in the inbox and compose outgoing mail.

The enterprise applications 326 may be any computer-readable instructions configured for satisfying needs of the business entity. Enterprise applications 322 may include electronic banking applications, online payment applications, billing application, enterprise content management application, and the like.

The office suites 329 may be any computer-readable instructions configured for day-to-day use of a computer including word processor applications, spreadsheet applications, presentation programs, database applications, desktop publishing software, and the like.

The Memory 315 for storing the browser application 316 and other data, like the other memory devices described herein, may include any computer-readable medium. For example, the memory 315 may include volatile memory, such as volatile Random Access Memory (RAM) including a cache area for the temporary storage of data. The memory 315 may also include other non-volatile memory, which can be embedded and/or may be removable. The non-volatile memory can additionally or alternatively comprise an EEPROM, flash memory, or the like. The memory 315 is communicatively coupled to the processor 314 and can store any of a number of pieces of information and data used by the user terminal 310 to implement the functions of the user terminal 310.

The user interface 318 is operatively coupled to the processor 314 and generally comprises one or more user output devices, such as a display and/or speaker, for presenting information to a user. The user interface 318 further comprises one or more user input devices, such as one or more keys or dials, a touch pad, touch screen, mouse, microphone, camera, and/or the like, for receiving information from the user.

FIG. 3 also illustrates the search front end 320 in accordance with an embodiment of the invention. In the illustrated embodiment, the search front end 320 is operatively coupled to the user terminal 310 and the central database 340 via the network 350 which may be an intranet for a business entity. As illustrated, the search front end 320 comprises a communication interface 322, processor 324, and memory 325. In one embodiment, the communication interface 322 comprises a Web server and an intranet server.

The memory 325 generally comprises a search application 327. The search application 327 comprises computer-readable instructions that generally instruct the processor 324 to initiate a search of a set of resources, such as the central database 340, using the search query provided by the user terminal 310. The search application 327 may initiate the search by performing the search itself or by requesting that an external entity conduct the search. The search may be performed by actually searching all of the set of resources for the keywords from the search query or by comparing the search query to an index generated from a database crawler. The memory 325 further includes a search result datastore 328 for storing the search results at least temporarily as the search results are being compiled by the search application 327 and communicated to the user terminal 310. For example, in one embodiment, in response to the search query “computer help” the search front end 320 is configured to return to the user terminal 310 one or more links to documents or information related to computer help.

Further, FIG. 3 depicts the database manager 330, which is operatively coupled to the central database 340, in accordance with an embodiment of the invention. As illustrated, the database manager 330 comprises a communication interface 332, a processor 334, and a memory 335 comprising a datastore 336 and a manager user interface 338.

The manager user interface 338 is in operable communication with processor 334 and generally comprises one or more user output devices, such as a display and/or speaker, for presenting information to a user. The manager user interface 330 further comprises one or more user input devices, such as one or more keys or dials, a touch pad, touch screen, mouse, microphone, camera, and/or the like for receiving information from the agent. The manager user interface 338 may be used to manage the central database 340.

FIG. 3 also illustrates a central database 340, which is in operable communication with search front end 320 and database manager 330, in accordance with an embodiment of the invention. As illustrated, the central database 340 comprises a communication interface 342, processor 344, and memory 345, where the memory 345 includes central datastore 348 and intake application 350.

The memory 345 may further comprise an intake application 350. The intake application 329 comprises computer-readable instructions that generally instruct the processor to receive or retrieve data from one or more data sources within a business entity, such as the e-mail application 320, the enterprise applications 326, and/or the office suites applications 329. The intake application 329 may receive information automatically from the plurality of data sources based on preferences of a user associated with any of the plurality of data sources.

Referring now to FIG. 4, a general process flow 400 of a method for managing a central database of the present invention is provided, in accordance with an embodiment of the present invention. As represented by block 410, the method receives input from a user for initiating a user interface for managing a central database of a business entity. As represented by the block 420, in response to receiving the input, the method presents a user interface for managing the central database of the business. As then represented by the block 430, the method receives input for configuring the central database.

Accordingly, the method having process flow 400 enables a technical help desk agent and/or manager to easily manage the information or data within the central database using an interface specifically configured for managing the central database.

Regarding the block 410, the method having process flow 410 receives input from a user for initiating an interface for managing a central database. In some embodiments, the input from the user comprises a selection of a selectable input feature associated with the search interface, such as an “Add/Remove” button. The Add/Remove button may be located directly on the search interface and in some embodiments, proximate to the search field of the search interface. Upon selecting the Add/Remove button, the method is configured to initiate one or more process for allowing the user to add, remove, or modify information within the central database. In some embodiments, requires authentication of a user attempting to add, remove, or modify information within the central database. In such an embodiment, upon selecting the Add/Remove button, the method presents an authentication screen requiring a passcode, PIN, or other authentication information. Once the user is successfully authenticated, the method allows the user to modify information within the central database within the scope of his access rights associated with his authentication information. In some embodiments, there are a limited number of users within the business entity with access rights for modifying information within the central database which primarily includes managers of the central database.

Turning to the block 420, in response to receiving input and/or a successful authentication of the user, the method present a user interface for managing the central database of the business. The user interface provides various features for managing the central database in a number ways including adding information, removing information, modifying/updating information, creating information/files/documents, repairing files/documents, arranging information, organizing information, and the like. In some embodiments, the method presents via the user interface the information, documents, and files in the knowledge base of the central database. In this way, a user can easily inspect and identify information stored within the central database.

Regarding the block 430, the method configures the central database or information within the central database based at least partially on one or more inputs received from the user. As a first example, using the user interface for managing the central database, a user may be allowed to add a single record to the knowledge base of the central database. In such an example, a user may add a single record to the central database by first entering a title or name for the record into a “New Record” field within the user interface. Once the a title is provided, a user may right-click within the New Record field so that options for that cell are presented and select a hyperlink option. Selecting the hyperlink option allows the user to identify the folder to which a new record is to be added and additionally, once the appropriate folder for the central database is identified, the user may then identify the record that he intends to add. The identified record may be added from a number of files or information within applications or locations within a computer of a user, such as an e-mail application, office suites applications, or a local drive within the computer of the user. Once the file or record is selected, a hyperlink having the title of the new record should appear together with other records represented by hyperlinks within the knowledge base for the central database.

As second example, using the user interface for managing the central database, a user is allowed to add multiple records having a same file format (e.g., pdf, docx, txt, xls, or the like) to the central database. Similar to adding a single record, a user may add the multiple records to the central database by first entering a title for each record within the New Record field of the user interface. Once a title for each of the multiple records is provided, a user may select a “Convert to Hyperlink” button, which is a selectable input feature that converts one or more titles or names provided for a document into a selectable hyperlink. Upon selecting the Convert to Hyperlink button the user is then allowed to identify the knowledge base folder for the central database, as the folder to which the records will be added. The user may then provide a file extension (e.g., txt) for the multiple records. Once the file extension for the multiple records is provided, the multiple records are automatically linked to a same file name in the knowledge base folder for the central database.

As a third example, using the user interface for managing the central database, a user is allowed to remove one or more record from the knowledge base of the central database. In such an example, a user may select the record that he intends to remove by right-clicking a hyperlink associated with a hyperlink that he intends to remove. By right-clicking the document, the user is provided a series of options for managing the record including deleting the record. By selecting a “Delete” button in the presented options, the record is removed from the knowledge base of the central database.

It will further be understood that the apparatus having the process flow 400 can be configured to perform any of the portions of the process flow 400 represented by blocks 410-430 upon or after one or more triggering events (which, in some embodiments, is one or more portions of process flow 400). As used herein, “triggering event” refers to an event that automatically triggers the execution, performance, and/or implementation of a triggered action, either immediately, nearly immediately, or sometime after (e.g., within minutes, etc.) the occurrence of the triggering event. For example, in some embodiments, the system having process flow 400 is configured such that the system receiving input from the user for initiating an interface for managing the central database (the triggering event) automatically and immediately or nearly immediately triggers the system to present the user interface for managing the central database of the business (the triggered action).

Also, it will be understood that, in some embodiments, a predetermined time and/or the passage of a predetermined period of time may serve to trigger one or more of the portions represented by the blocks 410-430. It will also be understood that, in accordance with some embodiments, the system having the process flow 400 is configured to automatically perform one or more of the portions of the process flow 400 represented by the blocks 410-430, whereas in other embodiments, one or more of the portions of the process flow 100 represented by the blocks 410-430 require and/or involve human intervention. Of course, in addition to the system having the process flow 400, it will be understood that any of the embodiments described and/or contemplated herein can involve one or more triggering events, triggered actions, automatic actions, and/or human actions.

In addition, it will be understood that, in some embodiments, the system having the process flow 400 (and/or a user thereof) is configured to perform each portion of the process flow 400, from start to finish, within moments, seconds, and/or minutes (e.g., within approximately 10-15 minutes, etc.). In some embodiments, the system having the process flow 400 can be configured to perform one or more portions of the process flow 400 in real time, in substantially real time, and/or at one or more predetermined times. Further, it will be understood that the number, order, and/or content of the portions of the process flow 400 are exemplary and may vary. It will further be understood that the system having the process flow 400 can be configured to perform any one or more of the portions of any one or more of the embodiments described and/or contemplated herein, including, for example, any one or more of the portions of the process flow 100.

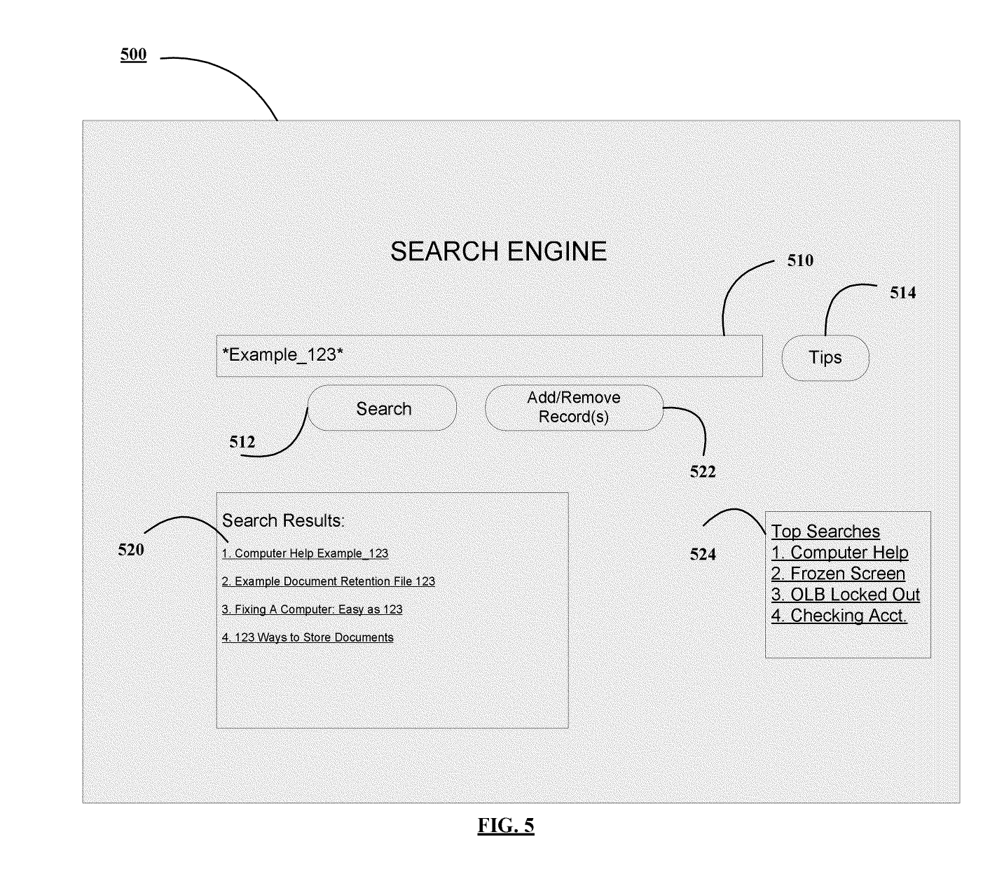

Referring now to FIG. 5, an exemplary search screen 500 is illustrated, in accordance with an embodiment of the present invention. Search screen 500 may be an Internet web page, an intranet web page, or some other user interface screen operatively connected with a system 200. Search screen 500 includes search field 510, search results list 520, and Add/Remove button 530.

Search screen 500 may be configured for use with any of the embodiments of the search engine described herein. For example, Search screen 500 may be a part of Browser Application 316 in System 300, as the means by which a user enters search queries, receives search results, and opens chat sessions in accordance with process flow 400. For simplicity, the following describes how search screen 500 interacts with the System 300, as it implements process flow 100. This is not meant to suggest that Search screen 500 cannot be configured for use with other systems associated with the search engine or implement other processes.

In operation, the agent enters a search query into the search field 510 of the Search screen 500 that is displayed to the agent using a display device of the user Interface 318 of the Terminal 310. If the user has difficulty determining what search query to enter or what form the search query should take, the search field 510 may provide a “Tips” button 514 that, when selected, will direct the agent to information related to these and other search field issues. Once the agent is satisfied with his or her search query, the agent selects the “Search” Button 512, which initiates the search processes described in process flow 100. If the agent desires to add or remove information from the knowledge database of the search engine, the interface may provide a “Add/Remove” button 522 that, when selected, will direct the agent to a separate interface for managing the knowledge base of the search engine.

After the search query is entered, the system 300 returns a search results list 520 to the Search screen 500. This list may include, for example, several links to other pages, documents, files, or the like related to the search query. As illustrated in FIG. 5, the exemplary search query “inoperable” may return the following exemplary links related to that search query: “Inoperable Operating System Application,” “Inoperable Authentication Page,” and “E-mail Does Not Operate.” It will be understood by one of ordinary skill in the art that the type, number, and content of results in the search results list 520 may vary and is not limited to those particular examples described herein.

In other embodiments of the present invention, the search results list 520 may include several other related features. For example, the search results list 520 may include a top searches tool 524, as illustrated in FIG. 5. In the illustrated embodiment, the Refine Search Results List tool (not shown) is configured to provide the agent with a series of expandable and collapsible links that shows the agent how information related to the exemplary search query “inoperable” is organized within the website. The Top Searches tool 524 is configured to present the agent with a list of the most frequently entered search queries by other agents, which may help the agent to refine his search query or identify another search of interest to the agent. The Search Results List 520 may also include a Search Results Feedback tool (not shown) to provide the agent with an opportunity to express the features that the agent likes and dislikes about the Search Results List 520 or any other feature in the search screen 500. All of these features are meant to enhance the agent experience.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed:

1. A centralized and searchable information system, the system comprising:
a network;
a central database configured to receive, via the network, information and documents from a plurality of data sources within a business entity;
a search interface configured to receive a search string; and
a search engine configured to:
(a) perform a search of the central database using the search string, wherein the search engine is in operable communication with the search interface and the central database, and
(b) output results of the search to a display associated with the search interface.

2. The system of claim 1, wherein the system further comprises a central database interface configured for managing the central database, wherein managing the central database includes adding or deleting information or documents from the central database.

3. The system of claim 2, wherein, using the central database interface, information and/or documents are entered into the central database.

4. The system of claim 1, wherein the results of the search comprise one or more hyperlinks linking to information and/or documents in the central database.

5. The system of claim 1, wherein the system further comprises a computer processor, wherein the computer processor identifies, at each of the plurality of data sources, information or documents relating to information or documents previously stored within the central database.

6. The system of claim 5, wherein the computer processor associates with each of the identified information or documents a selectable input feature, when selected by a user, automatically copies the information or documents from the data source to the central database.

7. The system of claim 5, wherein identifying the information or documents comprises associating an indicator with each of the identified information or documents, wherein the indicator is any one or more of a highlighting, flagging, or otherwise differentiating the identified information or documents from other information or documents at the data source.

8. A computer program product for providing a searchable central database, the computer program product comprising a non-transitory computer-readable medium, wherein the non-transitory computer-readable medium comprises one or more computer-executable program code portions that, when executed by a computer, cause the computer to:
provide a search engine tool configured for searching a central database receiving information and documents from a plurality of data sources within a business entity;
receive, via the search engine tool, a search query;
in response to receiving the search query, perform, by a computer process, a search of the central database; and
provide results of the performed search.

9. The computer program product of claim 8, wherein the computer program code further comprises one or more executable program portions that cause the computer to provide a central database interface configured for managing the central database, wherein managing the central database includes adding or deleting information or documents from the central database

10. The computer program product of claim 9, wherein, using the central database interface, information and/or documents are entered into the central database.

11. The computer program product of claim 9, wherein the results of the search comprise one or more hyperlinks linking to information and/or documents in the central database.

12. The computer program product of claim 11, wherein the computer program code further comprises one or more executable program portions that cause the computer to identify, at each of the plurality of data sources, information or documents relating to information or documents previously stored within the central database.

13. The computer program product of claim 12, wherein the computer program code further comprises one or more executable program portions that cause the computer to associate with each of the identified information or documents a selectable input feature, when selected by a user, automatically copies the information or documents from the data source to the central database.

14. A method for providing a searchable central database, the method comprising:
providing a search engine tool configured for searching a central database receiving information and documents from a plurality of data sources within a business entity;
receiving, via the search engine tool, a search query;
in response to receiving the search query, performing, by a computer process, a search of the central database; and
providing results of the performed search.

15. The method of claim 15, wherein the method further comprises a central database interface configured for managing the central database, wherein managing the central database includes adding or deleting information or documents from the central database.

16. The method of claim 15, wherein, using the central database interface, information and/or documents are entered into the central database.

17. The method of claim 15, wherein the results of the search comprise one or more hyperlinks linking to information and/or documents in the central database.

18. The method of claim 17, wherein computer processor identifies, at each of the plurality of data sources, information or documents relating to information or documents previously stored within the central database.

19. The method of claim 17, wherein the computer processor identifies, at each of the plurality of data sources, information or documents relating to information or documents previously stored within the central database.

20. The method of claim 17, wherein the computer processor associates with each of the identified information or documents a selectable input feature, when selected by a user, automatically copies the information or documents from the data source to the central database.
